(19) United States
(12) Patent Application Publication
(10) Pub. No.: US 2021/0017045 A1
(43) Pub. Date: Jan. 21, 2021

(54) GAS PHASE PHOTOLYTIC OXIDATION FOR WATER PURIFICATION

(71) Applicant: Paragon Space Development Corporation, Tucson, AZ (US)

(72) Inventors: Barry Wynns Finger, Santa Fe, TX (US); Brittany Lynn Zimmerman, Tucson, AZ (US)

(21) Appl. No.: 16/948,819

(22) Filed: Oct. 1, 2020

Related U.S. Application Data
(63) Continuation-in-part of application No. 16/808,147, filed on Mar. 3, 2020.
Application No. 16/808,147 is a division of application No. 16/118,325, filed on Aug. 30, 2018, now abandoned.
Application No. 16/118,325 is a continuation-in-part of application No. 15/704,889, filed on Sep. 14, 2017, now Pat. No. 10,752,523.
(60) Provisional application No. 62/396,011, filed on Sep. 16, 2016.

(51) Int. Cl. C02F 1/04; C02F 1/44; B01D 5/00; B01D 3/14; B01D 61/36; B01D 3/34; B01D 53/28; B01D 53/72; B01D 53/26

(52) U.S. Cl. CPC C02F 1/048; C02F 1/447; B01D 5/006; B01D 5/0072; B01D 3/145; B01D 71/36; B01D 3/346; B01D 53/28; B01D 53/72; B01D 53/268; B01D 61/364; B01D 61/366

(57) ABSTRACT

This disclosure provides a water purification system for recovery of purified water from liquid wastewater. The liquid wastewater is converted to a contaminated gas stream using a water distillation technique. The contaminated gas stream is passed through a gas phase photolytic oxidation reaction chamber. An ultraviolet (UV) source in the gas phase photolytic oxidation reaction chamber exposes the contaminated gas stream to UV radiation to remove various contaminants in the gas phase and/or biological pathogens. The gas phase photolytic oxidation reaction chamber forms a purified gas stream from the contaminated gas stream, where the purified gas stream contains water vapor and is substantially free of contaminants. In some embodiments, an ionomer membrane may be placed downstream of a source of the liquid wastewater and upstream of the gas phase photolytic oxidation reaction chamber to treat the contaminated gas stream prior to UV exposure.

### STATEMENT REGARDING FEDERALLY SPONSORED RESEARCH OR DEVELOPMENT

Some embodiments of this invention were made with United States Government Support under Contract No. 80NSSC18C0191 awarded by the National Aeronautics and Space Administration (NASA). The U.S. Government has certain rights in this invention.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### TECHNICAL FIELD

This disclosure relates to systems, apparatuses, and methods of water decontamination or purification in the gas phase, and more particularly to systems, apparatuses, and methods of using an ultraviolet photolytic oxidation reactor for water decontamination in the gas phase.

### BACKGROUND

One of the most important resources for human support is potable water. Large populations in our world lack access to potable water and access to adequate sanitation. In addition, potable water is important for long-term human missions in space, where such water may be vital for consumption, hygiene, and maintenance. Since supplies of potable water may not be readily available, water reclamation to generate potable water from wastewater is essential. Sources of wastewater in long-term space missions can consist of hygiene water, laundry water, humidity condensate, brines, and human waste (e.g., urine). Due to the high cost of delivering supplies to space, recovery of potable water from wastewater may be critical to life support of crew members. Long duration space missions to the moon, Mars, and near-Earth asteroids may be mass-constrained and may require robust and reliable life support hardware. Closing the water loop on long duration space missions can be crucial to reducing mission mass, cost, and logistics support for orbiting facilities and planetary spacecraft.

Water recovery from wastewater is not only important in space applications, but can also be important in terrestrial applications. Such terrestrial applications of water recovery can include water recycling in arid regions, water treatment for disaster relief, greywater recycling onboard ships, and water recycling at long-term military outposts, ships, and submarines.

### SUMMARY

The systems, methods and devices of this disclosure each have several innovative aspects, no single one of which is solely responsible for the desirable attributes disclosed herein.

One innovative aspect of the subject matter described in this disclosure can be implemented in a system for producing purified water from contaminated water. The system includes a water distillation source configured to convert liquid wastewater into a contaminated gas stream comprising water vapor and contaminants, a gas phase photolytic oxidation reaction chamber spatially separated from and fluidly coupled to the water distillation source via an inlet for receiving the contaminated gas stream, an ultraviolet (UV) source in the gas phase photolytic oxidation reaction chamber, where the UV source is configured to expose the contaminated gas stream passing through the reaction chamber with UV radiation to remove the contaminants and form a purified gas stream, and a condenser spatially separated from and fluidly coupled to the gas phase photolytic oxidation reaction chamber via an outlet for receiving the purified gas stream.

In some implementations, the water distillation source includes an evaporation container configured to store the liquid wastewater, and a heat source thermally coupled to the evaporation container, where the heat source is configured to heat the wastewater to produce the contaminated gas stream. In some implementations, the system further includes an ionomer membrane positioned downstream of the water distillation source and upstream of the gas phase photolytic oxidation reaction chamber, where the ionomer membrane is permeable to the water vapor and impermeable to at least some of the contaminants. In some implementations, the UV source is configured to expose the contaminated gas stream with UV radiation at wavelengths between about 185 nm and about 400 nm. In some implementations, the gas phase photolytic oxidation reaction chamber has a first side to which the inlet is coupled and a second side to which the outlet is coupled, wherein the second side is opposite the first side, where the UV source extends longitudinally from the first side to the second side. In some implementations, an interior of the gas phase photolytic oxidation reaction chamber is coated with a reflective material. In some implementations, the gas phase photolytic oxidation reaction chamber is maintained at vacuum pressure and at a temperature less than about 400° C. when exposing the contaminated gas stream with UV radiation. In some implementations, the contaminants include one or more hydrocarbons in the gas phase. In some implementations, the contaminants include one or more microbes. In some implementations, a mass percent of water vapor is substantially greater than a mass percent of the contaminants in the contaminated gas stream. In some implementations, the system further includes an oxidation product removal chamber positioned downstream from the gas phase photolytic oxidation reaction chamber and upstream of the condenser, wherein the oxidation product removal chamber is configured to remove intermediate products generated from the gas phase photolytic oxidation reaction chamber.

Another innovative aspect of the subject matter described in this disclosure can be implemented in a method of recovering purified water from wastewater. The method includes receiving a contaminated gas stream comprising water vapor and contaminants in a gas phase photolytic oxidation reaction chamber, exposing the contaminated gas stream to UV radiation using a UV source in the gas phase photolytic oxidation reaction chamber to remove the contaminants and form a purified gas stream, and providing the purified gas stream to a condenser.

In some implementations, the method further includes converting liquid wastewater into the contaminated gas stream prior to receiving the contaminated gas stream in the gas phase photolytic oxidation reaction chamber. In some implementations, the method further includes flowing the contaminated gas stream to an ionomer membrane prior to receiving the contaminated gas stream in the gas phase photolytic oxidation reaction chamber, where the ionomer membrane is permeable to the water vapor and impermeable to at least some of the contaminants. In some implementations, the method further includes condensing the purified gas stream to purified water in the condenser. In some implementations, the UV source is configured to expose the contaminated gas stream with UV radiation at wavelengths between about 185 nm and about 400 nm. In some implementations, the gas phase photolytic oxidation reaction chamber is maintained at vacuum pressure and at a temperature less than about 400° C. when exposing the contaminated gas stream with UV radiation. In some implementations, the contaminants include one or more hydrocarbons in the gas phase. In some implementations, a mass percent of water vapor is substantially greater than a mass percent of the contaminants in the contaminated gas stream. In some implementations, exposing the contaminated gas stream to UV radiation comprises penetrating with the UV radiation through an entirety or substantial entirety of the contaminated gas stream in the gas phase photolytic oxidation reaction chamber.

### BRIEF DESCRIPTION OF THE DRAWINGS

FIG. 1 shows a schematic block diagram of a water purification system using an ultraviolet photolytic oxidizer on contaminated water.

FIG. 2 shows a schematic block diagram of an example system for recovering purified water from liquid wastewater according to some implementations.

FIG. 3 shows a flow diagram of an example method of recovering purified water from wastewater according to some implementations.

FIG. 4A shows a schematic illustration of an example gas phase photolytic oxidation reaction chamber according to some implementations.

FIG. 4B shows a cross-sectional schematic illustration of the gas phase photolytic oxidation reaction chamber of FIG. 4A according to some implementations.

FIG. 5 shows a schematic system diagram illustrating an example system for recovering purified water from liquid wastewater incorporating additional features such as thermal energy introduction and removal to drive a water transport process, forced convection to transport water vapor, energy recovery devices such as heat exchangers to reduce energy use, and a tertiary water treatment process to further purify the product water according to some implementations.

FIG. 6 shows a schematic system diagram illustrating an example system for recovering purified water from liquid wastewater including a gas phase photolytic oxidation reaction chamber according to some implementations.

Like reference numbers and designations in the various drawings indicate like elements.

### DETAILED DESCRIPTION

Many industries generate wastewater that is not usable or practical for drinking, agriculture, commercial use, and disposal. The wastewater may contain a high concentration of brine, contaminants, or other chemicals. Wastewater can come from a variety of sources, including but not limited to humidity condensate from air conditioning systems, hygiene water, seawater, polluted water, hydraulic fracturing water, greywater, brine, and urine. In one example, human urine can include several different inorganic salts, urea, organic ammonium salts, and other organic compounds. Human urine also includes water, the percentage of which can vary from person to person. In another example, water recycled from hydraulic fracturing can include several different chemical additives such as silica, quartz sand, hydrochloric acid, polyacrylamide, isopropanol, guar gum, hydroxyethyl cellulose, sodium carbonate, potassium carbonate, ammonium persulfate, citric acid, borate salts, N,N-dimethyl formamide, and glutaraldehyde along with volatile organic compounds, salts, and more.

Treatment of wastewater can occur using a variety of strategies. Filtration may remove particles through fine physical barriers such as screens or sieves. Impurities may be separated from water using methods like ion exchange, reverse osmosis, and distillation. Gravity separation is another treatment process that takes advantage of density differences between water and suspended solids. Many organic compounds or organic pollutants can be removed by biochemical oxidation and/or chemical oxidation, where disinfection by chemical oxidation may remove microbial pathogens by adding chemicals like ozone, chlorine, or hypochlorite to the wastewater. Polishing may occur after some of the aforementioned treatments to remove trace contaminants and impurities. For example, activated carbon may remove such trace contaminants and impurities by chemical absorption.

Common water purification technologies including distillation, reverse osmosis, and carbon filtration usually produce suitable water quality, but may require high capital, operation, and maintenance costs. Alternative water purification technologies including low and medium pressure mercury vapor ultraviolet (UV) radiation may be effective for reducing pathogen levels and organics in chemically contaminated water. However, UV radiation for treatment of chemically contaminated water may require high amounts of power, may require a large physical footprint, and oxidation products may be incomplete and require further processing for removal. Furthermore, UV lamps become easily fouled in a liquid water environment from various precipitated solids and contaminants, and this fouling reduces UV output. As a result, the UV lamps must be periodically cleaned or even replaced.

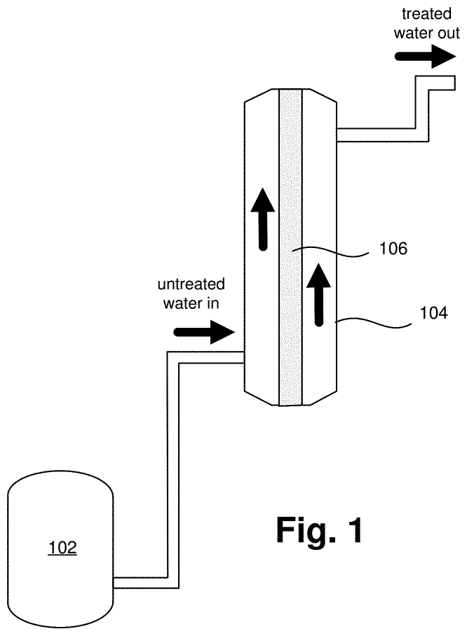

FIG. 1 shows a schematic block diagram of a water purification system using an ultraviolet photolytic oxidizer on contaminated water. Contaminated water 102 in an aqueous stream may be introduced into a water purification system 100 to be treated by a UV photolytic oxidizer 104. The UV photolytic oxidizer 104 may also be referred to as a UV photolytic oxidation reaction chamber or UV photolytic oxidation reactor. The contaminated water 102 may contain contaminants such as pesticides, pathogens, and organic compounds. The UV photolytic oxidizer 104 includes a UV source 106 such as a low-pressure mercury vapor lamp, medium-pressure mercury vapor lamp, high-pressure mercury vapor lamp, or other UV source. The contaminated water 102 may be flow through the ultraviolet photolytic oxidizer 104 to be exposed to UV radiation.

UV radiation can include wavelengths in the range of 10-400 nm. In some instances, the wavelengths are in the range of 185-400 nm for performing UV photolytic oxidation. Radiant values produced by the UV source 106 may be sufficient to dissociate bonds of organic molecules. Or, the radiant values produced by the UV source 106 may be sufficient to activate certain atomic bonds in the organic molecules to be more susceptible to oxidation. The UV radiation produces hydroxyl radicals (OH.), which can occur through reactions with water or other oxidants such as hydrogen peroxide or ozone. The hydroxyl radicals are highly reactive and lead to the breakdown of the organic molecules by oxidation. With sufficient oxidation and exposure to UV radiation, the reaction byproducts eventually include carbon dioxide, water, and/or an appropriate inorganic salt.

The UV photolytic oxidizer 104 may be a reaction chamber that brings the contaminated water 102 in close proximity to the UV source 106. Having the contaminated water 102 in close contact or proximity to the UV source 106 ensures that the UV radiation penetrates the contaminated water 102 to a sufficient depth to reach contaminants. This is due in part to Lambert's law that describes the decrease in light intensity with distance penetrated in a medium. In addition, increased levels of contaminants may exacerbate the problems of light transmission. The reaction chamber may permit a long enough residence time for penetration of UV radiation or may permit multiple passes to repeatedly bring the contaminated water 102 in close proximity to the UV source 106. After one or more passes in the UV photolytic oxidizer 104, the contaminated water 102 in the aqueous stream becomes less contaminated.

The UV photolytic oxidizer 104 in FIG. 1 presents an example water purification system 100 that has been used treat aqueous wastewater streams.

On the International Space Station (ISS), an environmental control and life support system (ECLSS) includes a water recovery system that recycles urine and washing water used by onboard astronauts to provide potable supply. Wastewater may be stabilized using pretreatment chemicals. The wastewater is then treated using a low pressure vacuum distillation process. The wastewater may be treated by multiple filters and by high temperature catalytic oxidation process and/or activated carbon. Thus, the water recovery system of the ECLSS may involve multi-filtration, ion exchange, activated carbon, and high temperature catalytic oxidation.

In some implementations of the present disclosure, a water recovery system provides increased robustness and reductions in mass, maintenance, and consumables. Aqueous wastewater is converted to a contaminated gas stream by a distillation process. In some implementations, a selective membrane, such as an ionomer membrane, separates the water vapor from the volatiles by selectively permeating the water vapor while rejecting the volatiles. Selective permeation of the water vapor can be driven by a water vapor partial pressure differential across the ionomer membrane. The selective membrane minimizes having moving parts in the water purification system. In the present disclosure, the contaminated gas stream is treated by a UV source in a gas phase photolytic oxidation reaction chamber. Again, this minimizes having moving parts in the water purification system. Moreover, this system reduces mass, maintenance, and consumables that would be otherwise associated with using activated carbon, and this system does not require as much thermal management or maintenance that is otherwise required in high temperature catalytic oxidation processes.

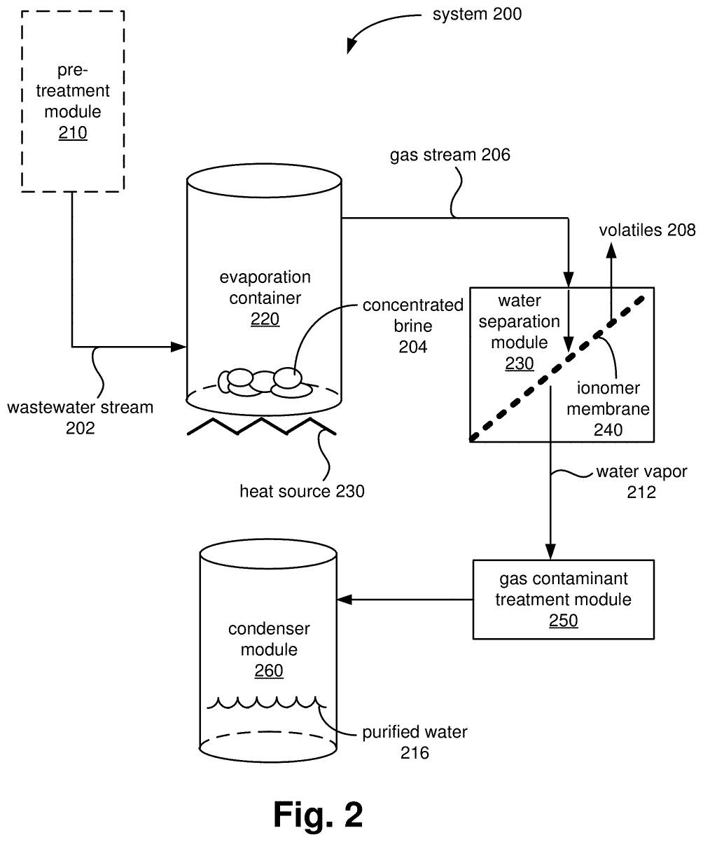

FIG. 2 shows a schematic block diagram of an example system for recovering purified water from liquid wastewater according to some implementations. The system 200 may recover purified water from wastewater for subsequent disposal, reuse, drinking, or sale, and the system 200 may separately recover concentrated brine for subsequent disposal, reuse, or sale. The system 200 includes multiple modules or chambers that are spatially separated from one another and fluidly coupled to one another for treating wastewater. The system 200 in FIG. 2 allows for separation of wastewater into purified water under a single process or a single processing system. In other words, purified water can be produced in a single processing system without requiring additional processing steps. Moreover, concentrated brine and purified water can each be self-contained as a result of the single processing system.

A wastewater stream 202 may be introduced into an evaporation container 220. In some implementations, the wastewater stream 202 may be pretreated prior to entering the evaporation container 220. For example, the wastewater stream 202 may be optionally pretreated by a pretreatment module 210. The pretreatment module 210 may serve to stabilize the wastewater stream 202 and/or reduce the levels of contaminants in the wastewater stream 202. It will be understood that while the pretreatment module 210 may perform a biological pretreatment, alternative forms of pretreatment may be performed by the pretreatment module 210. The wastewater stream 202 may include various contaminants, salts, and organic compounds. The wastewater stream 202 may include but is not limited to dissolved organic compounds, nitrogen, ammonium (NH₄⁺), free ammonia (NH₃), nitrate (NO₃⁻), nitrogen dioxide (NO₂⁻), chloride (Cl⁻), sulfate (SO₄²⁻), phosphate (PO₄³⁻), calcium ions (Ca²⁺), magnesium ions (Mg²⁺), sodium ions (Na⁺), potassium ions (K⁺), total dissolved solids, and total suspended solids. The wastewater stream 202 may also include various microbes or biological pathogens such as bacteria, viruses, and protozoa. Some possible pathogens may include Enterobacter cloacae, Enterococcus faecalis, Escherichia coli (e.g., Salmonella and Shigella), Klebsiella pneumoniae, Proteus vulgaris, and Pseudomonas aeruginosa. The pretreatment module 210 treats the wastewater stream 202 prior to introduction in the evaporation container 220.

The evaporation container 220 may serve as a tank, vessel, or storage unit for the wastewater stream 202. The evaporation container 220 may be sealed or protected from the ambient environment. In some implementations, the evaporation container 220 may be thermally coupled with a heat source 230. The heat source 230 may be configured to heat the wastewater stream 202 in the evaporation container 220 to cause water and other contaminants to evaporate, thereby producing a gas stream 206 comprising water vapor 212 and volatiles 208 such as volatile organic compounds (VOCs). The volatiles may include hydrocarbons in the gas phase. Examples include aldehydes, alcohols, ketones, alkanes, alkenes such as benzene, and organic acids. The residual byproduct of the wastewater stream 202 remaining in the evaporation container 220 after evaporation may be a concentrated brine 204. The concentrated brine 204 may include residual solids of various salts and other compounds.

The heat source 230 may produce a sufficiently high temperature in the evaporation container 220 to cause evaporation of water and various contaminants into water vapor and volatiles. In some implementations, the heat source 230 may be an external heat source that may be fueled by combustion, electricity, or other suitable means. In some implementations, the heat source 230 may include a regenerative heat exchanger that is configured to cycle heat from a condenser 260 to the evaporation container 220. Accordingly, the heat recovered from condensation may be recycled to evaporate the wastewater stream 202 for improved energy efficiency.

In some implementations, the temperature for evaporation of the wastewater stream 202 is between about 25° C. and about 100° C. or between about 40° C. and about 70° C. In some implementations, the pressure for evaporation of the wastewater stream 202 upon exiting the evaporation container 220 is between about 1 kPa and about 101 kPa or between about 10 kPa and about 101 kPa. For example, the pressure in the evaporation container 220 may be below atmospheric pressure to promote evaporation of the wastewater stream 202. This may be facilitated by applying a compressor or vacuum pump downstream of the evaporation container 220, where the compressor or vacuum pump is located between the evaporation container 220 and a water separation module 230. That way, the water in the wastewater stream 202 my phase change from liquid to gas at a temperature below 100° C., e.g., such as about 85° C., 80° C., 75° C., 70° C., 65° C., 60° C., 55° C., 50° C., etc. By way of an example, the pressure in the evaporation container 220 may be about 12 kPa and the temperature may be about 50° C. to promote vaporization.

The gas stream 206 flows from the evaporation container 220 to the water separation module 230. The water separation module 230 is spatially separated from the evaporation container 220 but fluidly coupled to the evaporation container 220 by one or more components. The water separation module 230 is spatially separated from the evaporation container 220 in that the water separation module 230 does not contact any of the wastewater stream 202 in the liquid phase. The water separation module 230 is fluidly connected to the evaporation container 220 to permit gas and vapor flow to and from the evaporation container 220. Mass transport of the gas stream 206 to the water separation module 230 may occur via forced convection and/or partial pressure differential.

In some implementations, the water separation module 230 includes a membrane for separating the water vapor 212 from the volatiles 208 in the gas stream 206. For instance, the membrane in the water separation module 230 includes an ionomer membrane 240. The ionomer membrane 240 may be substantially permeable to water vapor 212 but substantially impermeable to one or more volatiles 208. As used herein, “substantially” in the context of rejecting volatiles refers to rejection of at least 75%, at least 80%, at least 85%, at least 90%, at least 95%, or at least 98% of the volatiles 208 in the water separation module 230. By way of an example, a weight percentage of one or more contaminants in the condensed water may be calculated with the ionomer membrane 240 and without the ionomer membrane 240. As used herein, “substantially” in the context of water vapor permeation may refer to permeation of at least 75%, at least 80%, at least 85%, at least 90%, at least 95%, or at least 98% of the water vapor 212 in the water separation module 230. In some implementations, the ionomer membrane 240 can include Nafion®. The ionomer membrane 240 may selectively permeate the water vapor 212 while substantially rejecting the volatiles 208 from the gas stream 206. The rejected volatiles 208 may concentrate together to be recollected, recycled, or vented out of the system 200. Moreover, the ionomer membrane 240 may reject various microbes and pathogens.

In one approach, forced convection may drive the water vapor 212 across the ionomer membrane 240 from a “dirty” side of the ionomer membrane 240 to a “clean” side of the ionomer membrane 240. The “dirty” side may also be referred to as a first surface or dirty surface of the ionomer membrane 240, and the “clean” side may also be referred to as a second surface or clean surface of the ionomer membrane 240. A fan or blower may facilitate mass transport of the water vapor 212 to the ionomer membrane 240. In another approach, a partial pressure differential may drive the water vapor 212 across the ionomer membrane 240 from the first surface of the ionomer membrane 240 to the second surface of the ionomer membrane 240. In some implementations, a compressor may be positioned downstream from the ionomer membrane 240 (e.g., between the water separation module 230 and a condenser 260) that reduces a water vapor partial pressure at the second surface to draw water vapor 212 across the ionomer membrane 240. In some implementations, a compressor may be positioned upstream from the ionomer membrane 240 (e.g., between the evaporation container 220 and the water separation module 230) that reduces a water vapor partial pressure at the evaporation container 220 but increases a water vapor partial pressure at the first surface of the ionomer membrane 240. The compressor may generate heat to form super-heated water vapor 212 in the gas stream 206. By the time the gas stream 206 reaches the ionomer membrane 240, the gas stream 206 may be heated to a temperature between about 75° C. and about 150° C. or between about 100° C. and about 135° C., such as about 115° C. By the time the gas stream 206 reaches the ionomer membrane 240, a water vapor partial pressure of the gas stream 206 may be between about 50 kPa and about 101 kPa, such as about atmospheric pressure at 101 kPa. The high water vapor partial pressure at the first surface of the ionomer membrane 240, which may be coupled with a low water vapor partial pressure at the second surface of the ionomer membrane 240, creates a significant partial pressure differential to drive water vapor 212 across the ionomer membrane 240.

The ionomer membrane 240 serves as a chemically selective membrane that allows compounds that bind to sulfonic acid groups to readily permeate through the ionomer membrane 240, including water. The ionomer membrane 240 is a chemically-sensitive membrane in that it selectively passes water through the ionomer membrane 240 based on chemical affinity. Rather than selectively removing water or other gases based on molecular size, the ionomer membrane 240 can remove water and other gases based on chemical affinity. For example, the ionomer membrane 240 can remove water and other gases based on their chemical affinity for sulfonic acid groups. In some implementations, the ionomer membrane 240 includes Nafion®.

While Nafion® is an illustrative example of a material for selectively separating water vapor, it will be understood that other materials or fluids may be used in the water separation module 230. Nafion® is a copolymer of tetrafluoroethylene and perfluro-3,6-dioxa-4-methyl-7-octene-sulfonic acid. It is an inert fluorocarbon polymer with ionic channels of sulfonic acid groups scattered throughout. Nafion® is highly resistant to chemical attack, as only alkali metals such as sodium are known to degrade Nafion® under normal temperatures and pressures. In fact, strong acids may be used to regenerate Nafion® if it has been exposed to solutions containing cations. Because of its inertness, Nafion® can be safely disposed in landfills. Nafion® does not burn in ambient air and is more flame-resistant than most other plastics, with a limiting oxygen index of 95%. Nafion® sheets are commercially available through Ion Power, Inc., which is a distributor of Nafion® under E. I. du Pont de Nemours and Company of Wilmington, Del.. Different thicknesses of Nafion® are commercially available, which can affect the permeation rates.

Nafion® includes a bulk fluorocarbon matrix with exposed sulfonic acid groups immobilized in the bulk fluorocarbon matrix. Unlike the fluorocarbon matrix, the sulfonic acid groups do not participate in chemical reactions. As a result, the sulfonic acid groups provide several important properties to Nafion®. First, Nafion® functions as an acid catalyst due to the strongly acidic properties of the sulfonic acid group. Second, Nafion® functions as an ion exchange resin when exposed to liquid solutions. Third, Nafion® can readily absorb water, from the vapor phase or the liquid phase. Each of the sulfonic acid groups can absorb up to 13 molecules of water. The sulfonic acid groups can form ionic channels through the fluorocarbon polymer, and water can be easily transported through these channels. Thus, Nafion® can serve as a selective, semi-permeable membrane to water vapor. In some implementations, the ionomer membrane 240 can be provided as a sheet or sheets of Nafion®. In some implementations, the Nafion® of the ionomer membrane 240 can be provided as tubes that can form Nafion® tube walls. Nafion® tubes may be commercially available through Perma Pure LLC of Toms River, N.J.

Nafion® can serve as a selective, semi-permeable membrane to water vapor for water purification because the sulfonic acid groups can pass water while rejecting other compounds, making it possible to separate water from other contaminants or volatiles. The fact that Nafion® acts as an ion exchange resin when exposed to liquids implies that Nafion® is more effective processing gases rather than liquid solutions. When gases and vapors encounter the Nafion®, the Nafion® selectively permeates water vapor while blocking or otherwise “retaining” the volatiles of other compounds. As used herein, “retaining” means that the volatiles of the compounds do not pass through the ionomer membrane 240. The retained volatiles can include various hydrocarbons, such as alkanes, alkenes, alkynes, double and triple-bonded organic compounds, and benzene, among others. In addition, the retained volatiles can include most inorganic compounds. Some of the volatiles may be retained by converting into another compound, where some compounds may be susceptible to acid catalysis, for example.

A geometric configuration of the ionomer membrane 240 may optimize membrane surface area in contact with the gas stream 206 to provide increased water production. An optimized membrane surface area may depend on a variety of factors, such as gas flow rates, membrane thickness, desired flux, desired water processing rate, size limitations, weight limitations, etc. In some implementations, the membrane surface area may be at least 0.8 m², at least 1 m², at least 3 m², at least 5 m², at least 8 m², at least 10 m², or between 100 m² and 2000 m². Increased surface area in the water separation module 230 may provide an increased flux, increased lifetime, and increased water processing rate for permeated water vapor 212. In some implementations, the ionomer membrane 240 may be a tube-and-shell geometry, where the ionomer membrane 240 includes a plurality of tubes. In some implementations, the ionomer membrane 240 may be a spiral-wound geometry. In some implementations, the ionomer membrane 240 may be of a stacked flat-sheet geometry.

Permeated water vapor 212 may flow from the water separation module 230 towards a condenser 260. A purge gas or dry sweep gas may circulate through the “clean” side of the water separation module 230 to carry the water vapor 212 towards the condenser 260. The water vapor 212 may condense at the condenser 260 for collection of purified water. In some implementations, the condenser 260 may be spatially separated from and fluidly coupled to the water separation module 230.

In some implementations, water vapor 212 and residual contaminants or volatiles may permeate across the ionomer membrane 240. For example, while an ionomer membrane 240 such as Nafion® may be effective in retaining alkanes and stable molecules such as benzene, along with most inorganic compounds, some organic compounds such as aldehydes, ketones, and organic acids may permeate. Such residual contaminants or volatiles may be further treated at a gas contaminant treatment module 250. Examples of polishing steps utilized in the gas contaminant treatment module 250 include but are not limited to activated carbon, UV photocatalytic oxidation, and UV photolytic oxidation. As discussed further below, the gas contaminant treatment module 250 may include a reaction chamber for UV photolytic oxidation for removing residual contaminants in the gas phase. The gas contaminant treatment module 250 may be configured to further remove inorganic and organic volatiles and/or residual contaminants from a gas stream flowing from the “clean” side of the water separation module 230. For example, various VOCs may still permeate across the ionomer membrane 240 and at least some of the VOCs may be removed from the gas stream prior to entering the condenser 260.

The condenser 260 may include a water tank or purified water tank for collection of purified water 216 from condensation of the water vapor 212. The condenser 260 may condense the water vapor 212 into the purified water 216. In some implementations, the condenser 260 is thermally coupled with or integrated with a condensing heat exchanger or regenerative heat exchanger. A regenerative heat exchanger may cycle heat generated from the condenser 260 back to the evaporation container 220. When the water vapor 212 condenses and forms the purified water 216, the purified water 216 can be stored in the condenser 260 to be subsequently transferred for local use or drinking. An amount of purified water 216 collected in the condenser 260 may be equal to or greater than 70%, equal to or greater than 75%, equal to or greater than 80%, equal to or greater than 85%, equal to or greater than 90%, equal to or greater than 95%, or equal to or greater than 98% of the water in the wastewater stream 202.

The present disclosure relates to a water purification system for recovery of purified water from liquid wastewater. The liquid wastewater is converted to a contaminated gas stream using any suitable water distillation technique. The water distillation technique may involve a water distillation source configured to convert the liquid wastewater into the contaminated gas stream, where the contaminated gas stream includes water vapor and contaminants in a gas phase. In some implementations, the contaminated gas stream further includes one or more microbes (e.g., suspended bacteria). In some implementations, the water distillation source includes an evaporation container configured to store the liquid wastewater and a heat source thermally coupled to the evaporation container. The contaminated gas stream is passed through a gas phase photolytic oxidation reaction chamber that includes a UV source. The UV source in the gas phase photolytic oxidation reaction chamber exposes the contaminated gas stream to UV radiation to remove one or more contaminants in the gas phase and/or one or more microbes. A purified gas stream is formed after exposure to UV radiation in the gas phase photolytic oxidation reaction chamber, where the purified gas stream is condensed to form purified water. In some implementations, an ionomer membrane may be positioned downstream of the water distillation source and upstream of the gas phase photolytic oxidation reaction chamber to treat the contaminated gas stream prior to UV exposure. Having the ionomer membrane prior to UV photolytic oxidation reduces the possibility of contaminant loading in the gas phase photolytic oxidation reaction chamber.

Gas phase photolytic oxidation treatment presents many advantages over conventional gas phase treatment or polishing techniques. Among such conventional gas phase treatments include using activated carbon and high temperature catalytic oxidation. Activated carbon acts positively on volatile and non-volatile organics and pathogens, but is a consumable that has a finite lifetime and has to be periodically replaced. Activated carbon can become a hazardous waste product and generally requires a high disposal or reactivation cost. In some cases, operating temperatures may adversely affect activated carbon beds. Furthermore, activated carbon may be limited in which contaminants it can selectively remove. High temperature catalytic oxidation is carried out at high temperatures that may be greater than about 400° C. High temperature catalytic oxidation is power-sensitive since providing such high temperatures may require large amounts of electrical power. The environment for high temperature catalytic oxidation must be carefully controlled to prevent catalyst poisoning. Furthermore, oxidation products can include acid gases that must be mitigated or removed.

UV photolytic oxidation in the gas phase effectively oxidizes various organics and pathogens by exposing a contaminated gas stream to UV radiation. Compared to UV photolytic oxidation in treatment of liquid wastewater, UV photolytic oxidation in the gas phase provides increased penetration depth through the contaminated gas stream. This results in shorter residence times when moving the contaminated gas stream through the reaction chamber. Furthermore, the UV source in UV photolytic oxidation in the gas phase is less susceptible to fouling compared to UV photolytic oxidation in the liquid phase.

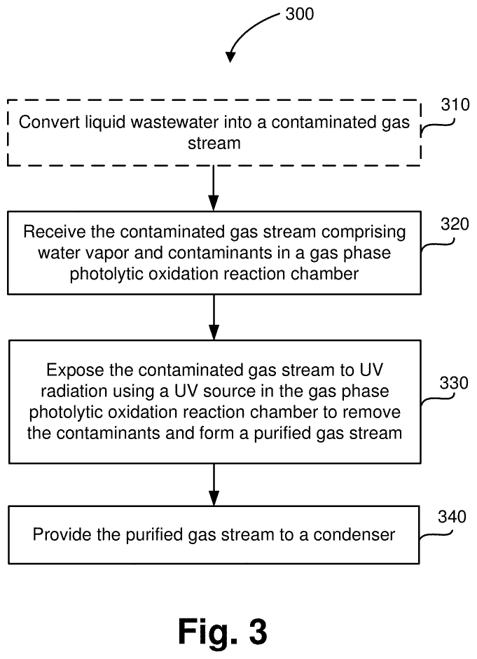

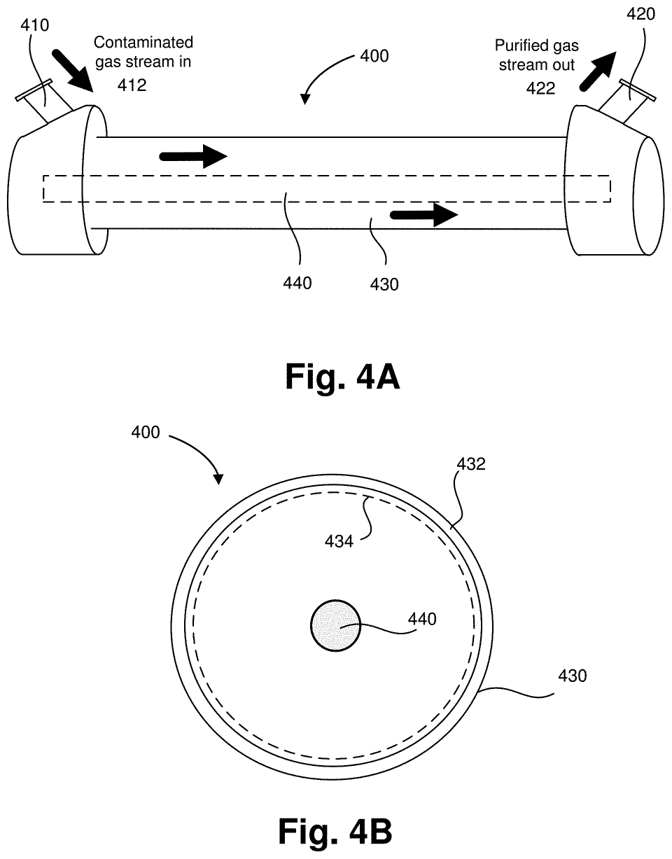

FIG. 3 shows a flow diagram of an example method of recovering purified water from wastewater according to some implementations. The operations in a process 300 of FIG. 3 may be performed in different orders and/or with different, fewer, or additional operations. In some implementations, the operations in the process 300 may be performed using systems and/or devices shown in FIGS. 4A, 4B, 5, and 6.

At block 310 of the process 300, liquid wastewater is optionally converted into a contaminated gas stream. Liquid wastewater influent may be provided to a water distillation source. The water distillation source may include an evaporation container thermally coupled to a heat source. In some implementations, the heat source may be an external heat source or regenerative heat exchanger. In addition to water, the liquid wastewater may include various contaminants such as salts, organics, ammonia, and biological pathogens. In some implementations, the liquid wastewater may be pretreated and stabilized prior to storage in the water distillation source.

The liquid wastewater is converted to the contaminated gas stream by distillation. The liquid wastewater may be heated by the heat source to a boiling point so that the liquid wastewater evaporates, forming the contaminated gas stream. In some implementations, a pressure in the water distillation source may be reduced to less than atmospheric pressure so that the liquid wastewater vaporizes at less than 100° C., such as about 85° C., 80° C., 75° C., 70° C., 65° C., 60° C., 55° C., 50° C., etc. In some implementations, the pressure in the water distillation source may be reduced by a compressor or vacuum pump. The contaminated gas stream includes a mixture of water vapor and contaminants in the gas phase (e.g., VOCs). In some implementations, the contaminated gas stream further includes one or more microbes (e.g., suspended bacteria). As used herein, it will be understood that the term “contaminated gas stream” may be inclusive of water vapor, contaminants in the gas phase such as VOCs, and microbes such as suspended bacteria or other biological pathogens.

At block 320 of the process 300, the contaminated gas stream comprising water vapor and contaminants is received in the gas phase in a gas phase photolytic oxidation reaction chamber. The gas phase photolytic oxidation reaction chamber may be spatially separated and downstream from the water distillation source. The contaminated gas stream may flow from the water distillation source to the gas phase photolytic oxidation reaction chamber. Upon reaching the gas phase photolytic oxidation reaction chamber, the contaminated gas stream includes one or more hydrocarbons in the gas phase. The contaminated gas stream may include contaminants in the gas phase such as ammonia, acetone, ethanol, methanol, formaldehyde, methane, benzene, carbon monoxide, nitrous oxide, octamethylcyclotetrasiloxane, hexamethylcyclotrisiloxane, or combinations thereof. Such contaminants may be treated by UV exposure in the gas phase photolytic oxidation reaction chamber.

In some implementations, a membrane module is optionally positioned between the water distillation source and the gas phase photolytic oxidation reaction chamber. This means that the membrane module is positioned downstream of the water distillation source and upstream of the gas phase photolytic oxidation reaction chamber. In some implementations, the membrane module includes an ionomer membrane. The ionomer membrane may include Nafion®. Properties of Nafion® for chemically separating water vapor from contaminants are discussed above. The ionomer membrane is permeable to water vapor and impermeable to at least some of the contaminants in the gas phase. For instance, the water vapor in the contaminated gas stream substantially permeates across the ionomer membrane while volatiles and microbes in the contaminated gas stream are substantially rejected. However, some volatiles and microbes may still permeate across the ionomer membrane in relatively small or trace amounts. Such contaminants may be equal to or less than about 2 mass % of the contaminated gas stream upon reaching the gas phase photolytic oxidation reaction chamber. In some implementations, water vapor in the contaminated gas stream is at least about 10 mass % or at least about 99 mass %. In other words, the mass percent of water vapor in the contaminated gas stream is substantially greater than the mass percent of contaminants.

The contaminated gas stream may flow to the membrane module, where a semi-permeable membrane such as the ionomer membrane separates water vapor from many of the contaminants in the contaminated gas stream. The water vapor may be driven across the ionomer membrane by forced convection or partial pressure differential. In some implementations, a compressor or vacuum pump positioned between the water distillation source and the membrane module may provide the contaminated gas stream at a high temperature (e.g., about 115° C.) and a high pressure (e.g., about 101 kPa).

The contaminated gas stream may pass through the membrane module to become a less contaminated gas stream with relatively small or trace amounts of contaminants. In some implementations, the less contaminated gas stream may be carried by a “clean” sweep gas that circulates between the second surface of the ionomer membrane and a condenser. The sweep gas may be a dry purge gas or dry sweep gas that flows across the second surface of the ionomer membrane to pick up water vapor molecules and carries the water vapor in the less contaminated gas stream to the gas phase photolytic oxidation reaction chamber.

The contaminated gas stream, whether treated by the membrane module or not, enters the gas phase photolytic oxidation reaction chamber at an inlet. The gas phase photolytic oxidation reaction chamber includes a first side to which the inlet is coupled and a second side to which an outlet is coupled. The gas phase photolytic oxidation reaction chamber further includes a UV source for exposing the contaminated gas stream to UV radiation. The contaminated gas stream may flow from the inlet to the outlet when exposed to the UV radiation. In some implementations, the UV source extends longitudinally from the first side to the second side of the gas phase photolytic oxidation reaction chamber.

At block 330 of the process 300, the contaminated gas stream is exposed to UV radiation using the UV source in the gas phase photolytic oxidation reaction chamber to remove the contaminants and form a purified gas stream. The contaminants may include contaminants in the gas phase. Examples of contaminants in the gas phase may include but are not limited to ammonia, acetone, ethanol, methanol, formaldehyde, methane, benzene, carbon monoxide, nitrous oxide, octamethylcyclotetrasiloxane, and hexamethylcyclotrisiloxane. Activated carbon and other conventional polishing techniques may not be effective in removing such contaminants. In some implementations, the contaminants may include microbes such as biological pathogens. Examples of biological pathogens may include but are not limited to bacteria, viruses, and protozoa. UV photolytic oxidation in the gas phase serves as a polishing step to effectively remove contaminants before condensing the water vapor.

Exposure to UV radiation produces highly reactive hydroxyl radicals (OH.), which in turn oxidize the contaminants in the contaminated gas stream to create simpler and simpler molecules that eventually can end up as water (H₂O) and carbon dioxide (CO₂). The highly reactive hydroxyl radicals may be produced from water or oxidant additives. Photolysis uses UV radiation to break molecules to create hydroxyl radicals. The hydroxyl radicals are able to break down most organic molecules by oxidation. With sufficient oxidation, the breakdown of organic molecules may lead to reaction byproducts of water, carbon dioxide, and/or an appropriate inorganic salt. Such organic molecules may include acetone, alcohols, hydrocarbons, and siloxanes. Other organic molecules may include vinyl chloride, benzene, toluene, ethylbenzene, and xylenes. Also, organisms or pathogens such as Salmonella and E. Coli have been significantly reduced using UV photolytic oxidation. Some target compounds like nitrous oxide may be addressed with the use of a higher power UV source (e.g., emitting about 185-nm wavelength) in order to produce ozone and/or oxygen radicals that would ultimately create nitrogen and oxygen molecules. This process may produce nitric oxide (NO) and/or nitrogen dioxide (N₂O), which may be broken down in a subsequent photolysis or polishing step. In some implementations, some of the molecules formed after photolysis may be referred to as intermediates that can be treated in an oxidation product removal chamber positioned downstream from the gas phase photolytic oxidation reaction chamber. The oxidation product removal chamber is configured to remove intermediate products generated from the gas phase photolytic oxidation reaction chamber.

The UV source may emit UV radiation in a range or in a single wavelength. The UV radiation may broadly include radiation at wavelengths from 10 nm to about 400 nm or from 185 nm to about 400 nm. The UV source may emit UV radiation in a continuous mode or pulsing mode. In some implementations, for example, low- and medium-pressure mercury UV lamps may radiate at a few wavelengths in the UV, such as 185 nm, 254 nm, and 365 nm. UV wavelengths selected at about 185 nm may facilitate oxidation reactions to degrade organic compounds. UV wavelengths selected at about 254 nm may facilitate germicidal properties for destruction of various pathogens.

In some implementations, the UV source is a single UV lamp extending longitudinally from the first side to the second side of the gas phase photolytic oxidation reaction chamber. The UV lamp may provide 360-degree circumferential radial radiation in the interior of the gas phase photolytic oxidation reaction chamber.

UV photolytic oxidation in the gas phase achieves deep penetration of UV radiation into the contaminated gas stream. Because the medium flowing through the gas phase photolytic oxidation reaction chamber is gas, UV radiation more easily transmits through the gas than through a liquid. The penetration depth in the liquid phase may typically be on the order of a few millimeters or less before UV radiation is absorbed, thereby requiring multiple passes of contaminated liquid streams to ensure contaminants are exposed to UV radiation. However, the penetration depth in the gas phase is generally greater than a few millimeters before UV radiation is absorbed. As a result, the residence time of the contaminated gas stream in the gas phase photolytic oxidation reaction chamber may be significantly reduced relative to a contaminated liquid stream. The contaminated gas stream does not undergo multiple passes through the gas phase photolytic oxidation reaction chamber. This increases the throughput of decontamination when operating in the gas phase. Furthermore, the lifespan of the UV source in the gas phase photolytic oxidation reaction chamber is improved before replacement or cleaning is needed. By processing in the gas phase instead of the liquid phase, the UV source is less susceptible to fouling.

In some implementations, an interior of the gas phase photolytic oxidation reaction chamber may be coated with reflective material. The reflective material may exhibit high reflectivity in the UV spectrum. The reflective material enables UV radiation to repeatedly reflect in the interior of the gas phase photolytic oxidation reaction chamber that increases the likelihood that contaminants are exposed to the UV radiation. Having a reflective coating reduces residence times and increases throughput.

The contaminated gas stream may be provided in the gas phase photolytic oxidation reaction chamber under low or vacuum pressure. However, it will be understood that in some implementations the contaminated gas stream may be provided in the gas phase photolytic oxidation reaction chamber at a high pressure such as ambient pressure. The contaminated gas stream may be provided in the gas phase photolytic oxidation reaction chamber at any suitable temperature such as less than about 400° C., between about 20° C. and about 150° C., between about 25° C. and about 135° C., or between about 100° C. and about 135° C.

Alternatively, in some implementations, the contaminated gas stream may be exposed to UV radiation for performing UV photocatalytic oxidation. In such instances, a catalyst such as titanium oxide (TiO₂) is exposed to UV radiation to excite electrons. The electrons may react with oxygen molecules and the resulting ions of TiO₂⁺ may react with water to eventually create a hydrogen peroxide molecule. The hydrogen peroxide molecule can be easily broken into highly reactive hydroxyl radicals by UV radiation that can destroy organic compounds and other contaminants. The catalyst may be incorporated in the contaminated gas stream. Other examples of catalysts include but are not limited to zinc oxide (ZnO), cadmium sulfide (CdS), and tungsten oxide (WO₃).

FIG. 4A shows a schematic illustration of an example gas phase photolytic oxidation reaction chamber according to some implementations. FIG. 4B shows a cross-sectional schematic illustration of the gas phase photolytic oxidation reaction chamber of FIG. 4A. A gas phase photolytic oxidation reaction chamber 400 includes an inlet 410 for receiving a contaminated gas stream 412 and an outlet 420 for releasing a purified gas stream 422. The contaminated gas stream 412 flows into a housing 430 of the gas phase photolytic oxidation reaction chamber 400 via the inlet 410, where the housing 430 of the gas phase photolytic oxidation reaction chamber 400 encloses the contaminated gas stream 412. In some implementations, the housing 430 of the gas phase photolytic oxidation reaction chamber 400 may include a metallic material such as stainless steel. In some implementations, interior walls 432 may line the housing 430, where the interior walls 432 of the housing 430 may include an insulating material such as quartz. In some implementations, the interior walls 432 of the housing 430 may be coated with a reflective material having a high reflectivity in the UV spectrum. The gas phase photolytic oxidation reaction chamber 400 further includes a UV source 440. The UV source 440 is enclosed in the housing 430 of the gas phase photolytic oxidation reaction chamber 400. The UV source 440 extends longitudinally across a length of the housing 430. The UV source 440 may be positioned to provide 360-degree circumferential radial radiation in the housing 430. In other words, the UV source 440 emits UV radiation radially outward towards the interior walls 432 of the housing 430 and along the length of the housing 430. In some implementations as shown in FIGS. 4A and 4B, the housing 430 is tubular and the UV source 440 is tubular. As the contaminated gas stream 412 flows through the gas phase photolytic oxidation reaction chamber 400 and is exposed to UV radiation from the UV source, contaminants are broken down and a purified gas stream 422 is formed.

Returning to FIG. 3, at block 340 of the process 300, the purified gas stream is provided to a condenser. The condenser may be spatially separated from and fluidly coupled to the gas phase photolytic oxidation reaction chamber. The condenser may be positioned downstream from the gas phase photolytic oxidation reaction chamber. Water vapor in the purified gas stream is collected at the condenser to form purified water. The condenser may include a water tank or storage vessel for collection of the purified water from condensation of the water vapor. In some implementations, the condenser is thermally coupled with or integrated with a condensing heat exchanger or regenerative heat exchanger. In some implementations, a regenerative heat exchanger may cycle heat generated from the condenser back to the water distillation source. When the water vapor condenses and forms the purified water, the purified water can be stored for subsequent disposal, drinking, reuse, or sale.

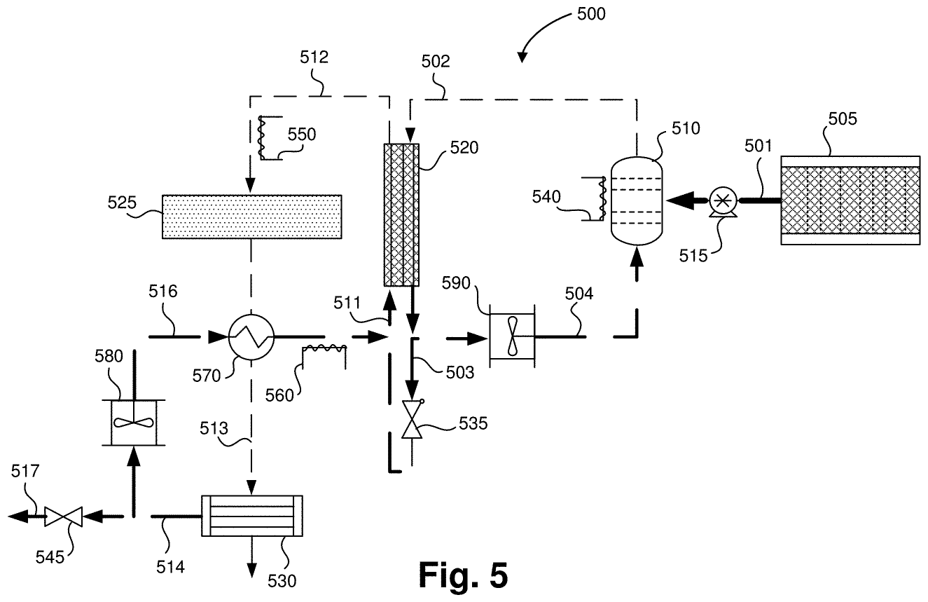

FIG. 5 shows a schematic system diagram illustrating an example system for recovering purified water from liquid wastewater incorporating additional features such as thermal energy introduction and removal to drive a water transport process, forced convection to transport water vapor, energy recovery devices such as heat exchangers to reduce energy use, and a tertiary water treatment process to further purify the product water according to some implementations. In a system 500, stabilized liquid wastewater 501 may be received from a pretreatment module 505 via a metering pump 515. The stabilized liquid wastewater 501 enters an evaporation container 510 for holding the stabilized liquid wastewater 501 and retaining residual solids after an evaporation operation. A heater 540 is thermally coupled to the evaporation container 510 to impart energy to the stabilized liquid wastewater 501 to perform an evaporation operation to form water vapor and volatiles (e.g., VOCs). In addition or in the alternative, one or more heaters 550, 560 may be positioned elsewhere in the system 500 to prevent condensation except at the condenser 530. A fan or blower 590 may provide dry carrier gas to the evaporation container 510 and carry the water vapor and volatiles in a humidified contaminant gas stream 502 towards a membrane module 520. The humidified contaminant gas stream 502 enters the membrane module 520 by forced convection on a “dirty” side of the membrane module 520. The membrane module 520 may provide a semi-permeable membrane that selectively permeates water vapor to a “clean” side of the membrane module 520 while substantially rejecting volatiles to the “dirty” side of the membrane module 520. The rejected volatiles in a de-humidified contaminant gas stream 503 may be vented to atmosphere or recirculated back to the evaporation container 510 at a check valve 535.

A fan or blower 580 may provide dry purge gas to the membrane module 520 at the “clean” side. The dry purge gas may carry permeated water vapor and any residual volatiles on the “clean” side in a humidified clean gas stream 512 towards a gas contaminant treatment module 525. Because some organics, acids, microbes, and other contaminants may permeate through the membrane module 520 to the “clean” side, the gas contaminant treatment module 525 may further treat and purify the humidified clean gas stream 512 to remove one or more such organics, acids, microbes, and contaminants. The gas contaminant treatment module 525 may include a gas phase photolytic oxidation reaction chamber with a UV source for exposing the humidified clean gas stream 512 to UV radiation. A humidified cleaner gas stream 513 is provided after treatment at the gas contaminant treatment module 525. The humidified cleaner gas stream 513 is flowed to a condenser module 530 with a condensing heat exchanger, where the condenser 530 condenses water vapor in the humidified cleaner gas stream 513 to purified water. Latent heat released by the condensation reaction may be cycled back to the evaporation container 510 by a regenerative heat exchanger 570. After condensation, a de-humidified cleaner gas stream 514 may recirculate back to the “clean” side of the membrane module 520 or vented back to atmosphere at check valve 545. Along a gas recirculation loop flowing between the membrane module 520 at the “clean” side and the condenser module 530, one or more heaters 550, 560 may be positioned to ensure that condensation does not take place except at the condenser module 530. Thus, a heater 550, 560, and/or 570 may be placed to heat up the liquid wastewater 501 at the evaporation container 510, with the humidified clean gas stream 512 on the “clean” side, or with a contaminated flow 516 returning to the evaporation container 510.

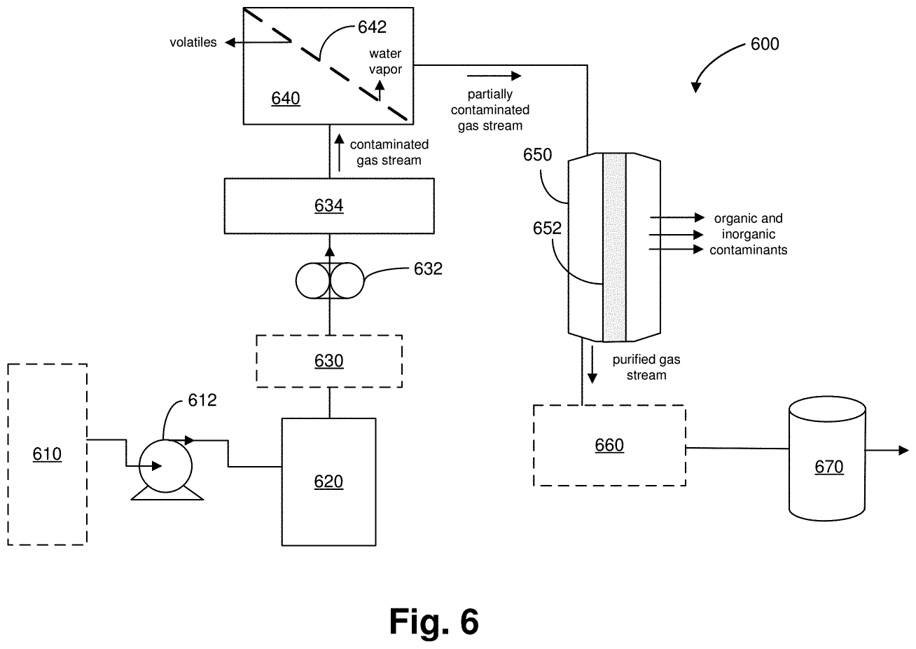

FIG. 6 shows a schematic system diagram illustrating an example system for recovering purified water from liquid wastewater including a gas phase photolytic oxidation reaction chamber according to some implementations. A water purification system 600 may include a pretreatment reactor 610 such as a biological wastewater processor, where liquid wastewater may be optionally treated and stabilized by the pretreatment reactor 610. Stabilized liquid wastewater may be received from the pretreatment reactor 610 via a metering pump 612. The stabilized liquid wastewater enters a water distillation source 620 such as an evaporation vessel as influent. A heat source (not shown) heats the stabilized liquid wastewater held in the water distillation source 620 to convert the stabilized liquid wastewater into a contaminated gas stream. The contaminated gas stream includes water vapor and volatiles (e.g., VOCs). In some implementations, the contaminated gas stream includes microbes (e.g., suspended bacteria). In some implementations, an ammonia scrubber 630 is positioned between the water distillation source 620 and a membrane module 640. The ammonia scrubber 630 serves to remove volatilized ammonia before reaching the membrane module 640. A compressor 632 is positioned between the membrane module 640 and the water distillation source 620. The compressor 632 may reduce a pressure in the water distillation source 620 so that water evaporates at a lower boiling point, and the compressor 632 may also increase a pressure at the “dirty” side of the membrane module 640. The compressor 632 may additionally increase a temperature of the contaminated gas stream after being scrubbed of ammonia. In other words, the contaminated gas stream moves through the compressor 632 with an inherent rise in both pressure and temperature. The compressor 632 may be coupled with an evaporative heat exchanger 634 that is downstream of the compressor 632 and upstream of the membrane module 640. The contaminated gas stream is passed through the evaporative heat exchanger 634 so that heat is removed and a temperature of the contaminated gas stream is lowered before entering the membrane module 640.

The membrane module 640 may include a semi-permeable membrane such as an ionomer membrane 642. The contaminated gas stream flows to the membrane module 640 and a partial pressure differential drives water vapor through the ionomer membrane 642 from a “dirty” side to a “clean” side while the ionomer membrane 642 rejects the volatiles and/or microbes. Buildup of the rejected volatiles on the “dirty” side of the ionomer membrane 642 may be vented using a pressure relief valve in the membrane module 640. The water vapor on the “clean” side of the ionomer membrane 642 may be contaminated with relatively small or trace amounts of contaminants that undesirably hitch across the ionomer membrane 642, thereby forming a partially contaminated gas stream on the “clean” side. The partially contaminated gas steam is flowed to a UV photolytic oxidation reaction chamber 650 positioned downstream of the membrane module 640. The UV photolytic oxidation reaction chamber 650 includes a UV source 652. The UV source 652 is configured to expose the partially contaminated gas stream to UV radiation to break down organics, inorganics, pathogens, and contaminants in the gas phase. The partially contaminated gas stream may flow in a single pass through the UV photolytic oxidation reaction chamber 650 to form a purified gas stream. In some implementations, an oxidation product removal chamber 660 is positioned downstream of the UV photolytic oxidation reaction chamber 650 to ensure removal of any intermediate products. Activated carbon or ion exchange beds are not necessary in the water purification system 600. A condenser 670 is positioned downstream of the UV photolytic oxidation chamber 650 and/or the oxidation product removal chamber 660 for condensing water vapor into purified water.

Although the foregoing disclosed systems, methods, apparatuses, processes, and compositions have been described in detail within the context of specific implementations for the purpose of promoting clarity and understanding, it will be apparent to one of ordinary skill in the art that there are many alternative ways of implementing foregoing implementations which are within the spirit and scope of this disclosure. Accordingly, the implementations described herein are to be viewed as illustrative of the disclosed inventive concepts rather than restrictively, and are not to be used as an impermissible basis for unduly limiting the scope of any claims eventually directed to the subject matter of this disclosure.

What is claimed is:

1. A system for producing purified water from contaminated water, the system comprising:
a water distillation source configured to convert liquid wastewater into a contaminated gas stream comprising water vapor and contaminants;
a gas phase photolytic oxidation reaction chamber spatially separated from and fluidly coupled to the water distillation source via an inlet for receiving the contaminated gas stream;
an ultraviolet (UV) source in the gas phase photolytic oxidation reaction chamber, wherein the UV source is configured to expose the contaminated gas stream passing through the reaction chamber with UV radiation to remove the contaminants and form a purified gas stream; and
a condenser spatially separated from and fluidly coupled to the gas phase photolytic oxidation reaction chamber via an outlet for receiving the purified gas stream.

2. The system of claim 1, wherein the water distillation source comprises:
an evaporation container configured to store the liquid wastewater; and
a heat source thermally coupled to the evaporation container, wherein the heat source is configured to heat the wastewater to produce the contaminated gas stream.

3. The system of claim 2, further comprising:
an ionomer membrane positioned downstream of the water distillation source and upstream of the gas phase photolytic oxidation reaction chamber, wherein the ionomer membrane is permeable to the water vapor and impermeable to at least some of the contaminants.

4. The system of claim 1, wherein the UV source is configured to expose the contaminated gas stream with UV radiation at wavelengths between about 185 nm and about 400 nm.

5. The system of claim 1, wherein the gas phase photolytic oxidation reaction chamber has a first side to which the inlet is coupled and a second side to which the outlet is coupled, wherein the second side is opposite the first side, wherein the UV source extends longitudinally from the first side to the second side.

6. The system of claim 1, wherein an interior of the gas phase photolytic oxidation reaction chamber is coated with a reflective material.

7. The system of claim 1, wherein the gas phase photolytic oxidation reaction chamber is maintained at vacuum pressure and at a temperature less than about 400° C. when exposing the contaminated gas stream with UV radiation.

8. The system of claim 1, wherein the contaminants include one or more hydrocarbons in the gas phase.

9. The system of claim 1, wherein the contaminants include ammonia, acetone, ethanol, methanol, nitrous oxide, octamethylcyclotetra siloxane, hexamethylcyclotrisiloxane, or combinations thereof.

10. The system of claim 1, wherein the contaminants include one or more microbes.

11. The system of claim 1, wherein a mass percent of water vapor is substantially greater than a mass percent of the contaminants in the contaminated gas stream.

12. The system of claim 1, further comprising:
an oxidation product removal chamber positioned downstream from the gas phase photolytic oxidation reaction chamber and upstream of the condenser, wherein the oxidation product removal chamber is configured to remove intermediate products generated from the gas phase photolytic oxidation reaction chamber.

13. A method of recovering purified water from wastewater, the method comprising:
receiving a contaminated gas stream comprising water vapor and contaminants in a gas phase photolytic oxidation reaction chamber;
exposing the contaminated gas stream to UV radiation using a UV source in the gas phase photolytic oxidation reaction chamber to remove the contaminants and form a purified gas stream; and
providing the purified gas stream to a condenser.

14. The method of claim 13, further comprising:
converting liquid wastewater into the contaminated gas stream prior to receiving the contaminated gas stream in the gas phase photolytic oxidation reaction chamber.

15. The method of claim 14, further comprising:
flowing the contaminated gas stream to an ionomer membrane prior to receiving the contaminated gas stream in the gas phase photolytic oxidation reaction chamber, wherein the ionomer membrane is permeable to the water vapor and impermeable to at least some of the contaminants.

16. The method of claim 13, further comprising:
condensing the purified gas stream to purified water in the condenser.

17. The method of claim 13, wherein the UV source is configured to expose the contaminated gas stream with UV radiation at wavelengths between about 185 nm and about 400 nm.

18. The method of claim 13, wherein the gas phase photolytic oxidation reaction chamber is maintained at vacuum pressure and at a temperature less than about 400° C. when exposing the contaminated gas stream with UV radiation.

19. The method of claim 13, wherein the contaminants include one or more hydrocarbons in the gas phase.

20. The method of claim 13, wherein a mass percent of water vapor is substantially greater than a mass percent of the contaminants in the contaminated gas stream.

21. The method of claim 13, wherein exposing the contaminated gas stream to UV radiation comprises penetrating with the UV radiation through an entirety or substantial entirety of the contaminated gas stream in the gas phase photolytic oxidation reaction chamber.
